(19) United States
(12) Patent Application Publication
(10) Pub. No.: US 2026/0005909 A1
(43) Pub. Date: Jan. 1, 2026

(54) PROBABILISTIC SHAPING AND SIGNAL DEMODULATION

(71) Applicant: QUALCOMM Incorporated, San Diego, CA (US)

(72) Inventors: Wei YANG, San Diego, CA (US); Mahmoud TAHERZADEH BOROUJENI, San Diego, CA (US); Jing JIANG, San Diego, CA (US)

(21) Appl. No.: 18/760,852

(22) Filed: Jul. 1, 2024

(51) Int. Cl. H04L 27/38; H04L 1/00; H04L 25/03

(52) U.S. Cl. CPC H04L 27/38; H04L 1/0054; H04L 25/03178

(57) ABSTRACT

Methods, systems, and devices for wireless communications are described. A wireless communication device may receive a communication signal that includes multiple layers. The signal may include at least one layer that is associated with a probabilistic shaping signal. The wireless communication device may apply one or more probabilistic shaping parameters to the communication signal and obtain a preprocessed signal. The application of the one or more probabilistic shaping parameters may include performing one or more matrix decomposition operations to obtain the preprocessed signal and a preprocessed channel estimate. The preprocessed signal and the preprocessed channel estimate may include probability information associated with the probabilistic shaping signal based on the application of the one or more probabilistic shaping parameters. Accordingly, the wireless communication device may demodulate the communication signal based on the preprocessed signal information.

### FIELD OF TECHNOLOGY

The following relates to wireless communications, including probabilistic shaping and signal demodulation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless communication device is described. The method may include receiving a communication signal that includes a set of multiple layers, where at least one layer of the set of multiple layers is associated with a probabilistic shaping signal, applying one or more probabilistic shaping parameters to the communication signal to obtain a preprocessed signal, where the preprocessed signal includes probability information associated with the probabilistic shaping signal based on the one or more probabilistic shaping parameters, and generating, subsequent to applying the one or more probabilistic shaping parameters, an estimate of the communication signal based on the preprocessed signal.

A wireless communication device for wireless communications is described. The wireless communication device may include one or more memories storing processor executable code, and one or more processors coupled with the one or more memories. The one or more processors may individually or collectively be operable to execute the code to cause the wireless communication device to receive a communication signal that includes a set of multiple layers, where at least one layer of the set of multiple layers is associated with a probabilistic shaping signal, apply one or more probabilistic shaping parameters to the communication signal to obtain a preprocessed signal, where the preprocessed signal includes probability information associated with the probabilistic shaping signal based on the one or more probabilistic shaping parameters, and generate, subsequent to applying the one or more probabilistic shaping parameters, an estimate of the communication signal based on the preprocessed signal.

Another wireless communication device for wireless communications is described. The wireless communication device may include means for receiving a communication signal that includes a set of multiple layers, where at least one layer of the set of multiple layers is associated with a probabilistic shaping signal, means for applying one or more probabilistic shaping parameters to the communication signal to obtain a preprocessed signal, where the preprocessed signal includes probability information associated with the probabilistic shaping signal based on the one or more probabilistic shaping parameters, and means for generating, subsequent to applying the one or more probabilistic shaping parameters, an estimate of the communication signal based on the preprocessed signal.

A non-transitory computer-readable medium storing code for wireless communications is described. The code may include instructions executable by one or more processors to receive a communication signal that includes a set of multiple layers, where at least one layer of the set of multiple layers is associated with a probabilistic shaping signal, apply one or more probabilistic shaping parameters to the communication signal to obtain a preprocessed signal, where the preprocessed signal includes probability information associated with the probabilistic shaping signal based on the one or more probabilistic shaping parameters, and generate, subsequent to applying the one or more probabilistic shaping parameters, an estimate of the communication signal based on the preprocessed signal.

Some examples of the method, wireless communication devices, and non-transitory computer-readable medium described herein may further include operations, features, means, or instructions for receiving an indication of the one or more probabilistic shaping parameters, where the one or more probabilistic shaping parameters may be applied based on the indication.

Some examples of the method, wireless communication devices, and non-transitory computer-readable medium described herein may further include operations, features, means, or instructions for receiving an indication that the at least one layer of the set of multiple layers may be associated with the probabilistic shaping signal, where the one or more probabilistic shaping parameters may be applied based on the indication.

In some examples of the method, wireless communication devices, and non-transitory computer-readable medium described herein, applying the one or more probabilistic shaping parameters may include operations, features, means, or instructions for applying the one or more first probabilistic shaping parameters to a first layer of the set of multiple layers and applying the one or more second probabilistic shaping parameters to a second layer of the set of multiple layers that may be different than the first layer.

Some examples of the method, wireless communication devices, and non-transitory computer-readable medium described herein may further include operations, features, means, or instructions for applying the one or more probabilistic shaping parameters to a channel estimate to obtain a preprocessed channel estimate, where the channel estimate may be associated with a channel over which the communication signal may be received, and where the estimate of the communication signal may be generated based on the preprocessed channel estimate.

In some examples of the method, wireless communication devices, and non-transitory computer-readable medium described herein, applying the one or more probabilistic shaping parameters to the communication signal may include operations, features, means, or instructions for performing a matrix decomposition operation on a matrix to obtain the preprocessed signal and a preprocessed channel estimate, where the matrix includes a channel estimate, one or more power scaling parameters associated with the set of multiple layers, and one or more probability distribution parameters associated with the set of multiple layers, or a combination thereof.

Some examples of the method, wireless communication devices, and non-transitory computer-readable medium described herein may further include operations, features, means, or instructions for obtaining the matrix based on combining a first matrix including the channel estimate and a second matrix including the one or more power scaling parameters and the one or more probability distribution parameters, where performing the matrix decomposition operation includes, decomposing the matrix into a third matrix and a fourth matrix, the third matrix including the preprocessed channel estimate and the fourth matrix including an orthogonal matrix, and applying the fourth matrix to the communication signal to obtain the preprocessed signal.

In some examples of the method, wireless communication devices, and non-transitory computer-readable medium described herein, the matrix decomposition operation includes a QR decomposition operation, a Cholesky decomposition operation, or both.

In some examples of the method, wireless communication devices, and non-transitory computer-readable medium described herein, the estimate of the communication signal includes one or more log-likelihood ratios for one or more information bits associated with the communication signal and the method, apparatuses, and non-transitory computer-readable medium may include further operations, features, means, or instructions for decoding the one or more information bits based on generating the one or more log-likelihood ratios.

In some examples of the method, wireless communication devices, and non-transitory computer-readable medium described herein, generating the estimate of the communication signal may include operations, features, means, or instructions for inputting the preprocessed signal and a preprocessed channel estimate to a uniform quadrature amplitude modulation (QAM) demodulator of the wireless communication device, where the uniform QAM demodulator generates the estimate of the communication signal based on the preprocessed signal and the preprocessed channel estimate.

Some examples of the method, wireless communication devices, and non-transitory computer-readable medium described herein may further include operations, features, means, or instructions for receiving a second communication signal including a second set of multiple layers, determining that the second set of multiple layers may be not associated with a probabilistic shaping signal, inputting the second communication signal and a channel estimate to the uniform QAM demodulator based on the determining, and generating a second estimate of the second communication signal based on the second communication signal and the channel estimate.

Some examples of the method, wireless communication devices, and non-transitory computer-readable medium described herein may further include operations, features, means, or instructions for performing a whitening operation to the communication signal and a channel estimate prior to applying the one or more probabilistic shaping parameters to the communication signal, where the whitening operation converts noise associated with the communication signal to white noise.

Some examples of the method, wireless communication devices, and non-transitory computer-readable medium described herein may further include operations, features, means, or instructions for determining that at least one second layer of the set of multiple layers may be not associated with a probabilistic shaping signal and setting a parameter of the one or more probabilistic shaping parameters associated with the at least one second layer to a value equal to 0 based on the determining, where generating the estimate of the communication signal may be based on setting the parameter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports probabilistic shaping and signal demodulation in accordance with one or more aspects of the present disclosure.

FIG. 2 shows an example of a network architecture that supports probabilistic shaping and signal demodulation in accordance with one or more aspects of the present disclosure.

FIG. 3 shows an example of a wireless communications system that supports probabilistic shaping and signal demodulation in accordance with one or more aspects of the present disclosure.

FIG. 4 shows an example of a processing diagram that supports probabilistic shaping and signal demodulation in accordance with one or more aspects of the present disclosure.

FIG. 5 shows an example of a process flow that supports probabilistic shaping and signal demodulation in accordance with one or more aspects of the present disclosure.

FIGS. 6 and 7 show block diagrams of devices that support probabilistic shaping and signal demodulation in accordance with one or more aspects of the present disclosure.

FIG. 8 shows a block diagram of a communications manager that supports probabilistic shaping and signal demodulation in accordance with one or more aspects of the present disclosure.

FIG. 9 shows a diagram of a system including a device that supports probabilistic shaping and signal demodulation in accordance with one or more aspects of the present disclosure.

FIGS. 10 through 12 show flowcharts illustrating methods that support probabilistic shaping and signal demodulation in accordance with one or more aspects of the present disclosure.

### DETAILED DESCRIPTION

Some wireless communication systems and devices may utilize communication schemes, such as multiple-input multiple-output (MIMO) communication schemes, in which a communication signal may include multiple layers. A “layer” may refer to an independent data stream that is transmitted simultaneously from one or more antennas, where the data stream may carry its own unique data and may be processed independently from other data streams. Accordingly, multiple streams of data (e.g., multiple layers) may be communicated simultaneously, which may enable increased data throughput and improved signal quality. As demand for faster data transmission increases, wireless communication systems may be expected to support multi-layer communication schemes (e.g., transmission and reception of MIMO signals). To accommodate such communications, some systems may utilize probabilistic shaping techniques (e.g., probabilistic amplitude shaping (PAS)) in which symbols (e.g., information bits) are modulated using non-uniform probability (e.g., using quadrature amplitude modulation (QAM) constellations with non-uniform amplitudes). However, the integration of probabilistic shaping into multi-layer modulation schemes (e.g., MIMO-capable systems) may result in increased processing complexity (e.g., in demodulation processes at the wireless communication device), increased power consumption, increased latency, and reduced communication quality, among other performance effects.

In accordance with aspects described herein, a wireless communication device (e.g., a receiver, a decoder, a UE, a network entity) may support one or more probabilistic shaping techniques that process (e.g., preprocess) a multi-layer signal prior to demodulation of the signal. In some examples, based on receiving a multi-layer signal (e.g., MIMO signal), the wireless device may apply one or more probabilistic shaping parameters to the signal and channel estimate metrics prior to inputting the signal and channel estimate to a demodulator. The application of the one or more probabilistic shaping parameters may result in a preprocessed signal and/or a preprocessed channel estimate that may be used by the demodulator to generate an estimate of the received signal (e.g., by demodulating the signal). Such techniques may reduce a complexity of demodulation in multi-layer communication scenarios (e.g., MIMO communication, in MIMO fading channels) by separating the effects of probabilistic shaping from the demodulation process. That is, based on applying the probabilistic shaping beforehand, the demodulator (e.g., a uniform QAM MIMO demodulator) may demodulate the preprocessed information (e.g., data that is preprocessed to include probabilistic shaping information) as if it were associated with a uniformly distributed signal (e.g., a signal modulated with uniform distribution of probabilities).

In some examples, application of the probabilistic shaping parameters may include performance of one or more matrix decomposition operations (e.g., such as QR or Cholesky decomposition) on a matrix formed of various channel parameter and probabilistic shaping parameters (e.g., channel estimation parameters, power scaling parameters, probability distribution parameters). The resulting matrices from the decomposition operations may be used to obtain the preprocessed information (e.g., a preprocessed signal, a preprocessed channel estimate) that may be input to the demodulator. Based on the demodulation, the device may generate one or more estimations of the received signal (e.g., including one or more log-likelihood ratios (LLRs) for each information bit of the signal). Thus, by separating the effect of probabilistic shaping on the received signal from the demodulation process, the wireless device may utilize relatively simpler demodulation components, which may achieve improved performance, reduced power consumption, and increased system capacity, among other benefits.

Aspects of the disclosure are initially described in the context of wireless communications systems. Aspects of the disclosure are further illustrated by and described with reference to processing diagrams, process flows, apparatus diagrams, system diagrams, and flowcharts that relate to probabilistic shaping and signal demodulation.

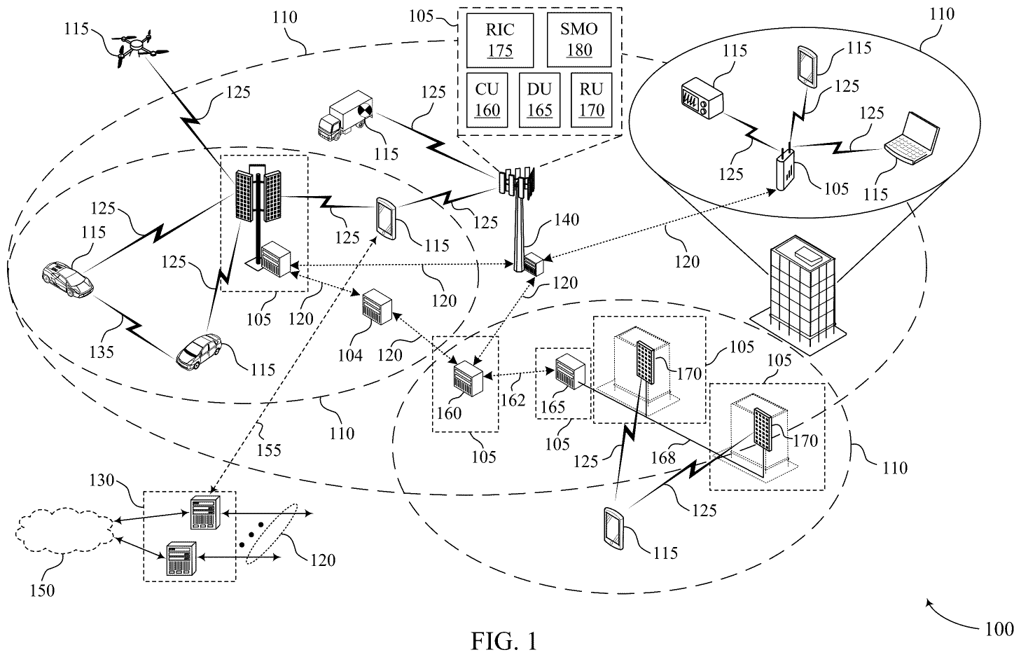

FIG. 1 shows an example of a wireless communications system 100 that supports probabilistic shaping and signal demodulation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems 100 may aim to improve (e.g., maximize) spectral efficiency (e.g., an information rate that is transmitted over a given bandwidth). In some cases, to increase spectral efficiency, the wireless communications system 100 may use non-uniformly distributed QAM constellations. QAM may refer to a modulation scheme that conveys data by changing the amplitude of one or more carrier waves, using a combination of amplitude modulation (AM) and phase shift keying (PSK). In some cases, each constellation point of the QAM (e.g., a particular symbol) may be associated with a probability. The probability may, in some cases, be determined based on a Maxwell-Boltzmann (MB) distribution, which may defined as p(x)˜e^{-v|x|}^{²}. The MB distribution may be used to maximize source entropy for a given average power, which may improve (e.g., optimize) the performance of the communication system.

Some techniques are directed to reducing a shaping gap (e.g., in terms of gains, a gap of 1.53 decibels (dB)) towards a metric (e.g., log (1+signal-to-noise (SNR))) associated with (e.g., over) an additive white gaussian noise (AWGN) channel. However, additional gains (e.g., greater than 2 dB) may be achievable when PAS is used in MIMO systems, (e.g., provided that the receiver is able to exploit the structure of the PAS in the interference layer), due to unique aspects associated with MIMO. To achieve such link level performance gains, a demodulator may be expected to support (e.g., exploit) the PAS prior information (e.g., probability distribution information used for modulation). In some examples, the PAS prior information (e.g., prior probability, a priori information) may refer to a probability associated with each constellation point (e.g., a likelihood that a given bit is able to be accurately decoded), which may be used to support the demodulation process.

In some cases, demodulating PAS in MIMO systems may present challenges, particularly when a non-linear demodulator is used by a network device such as a UE 115 or a network entity 105. For instance, in PAS systems, constellation points in both the signal layer and interference layers may be associated with prior probability information, which may be different (e.g., for each layer). Incorporating such prior probability information (e.g., symbol priors) in the demodulator of the device may be relatively complex (e.g., consuming a relatively high amount of processing resources). In some cases, the prior information may further disrupt a lattice structure of the QAM constellations, thus affecting performance of a demodulator (e.g., non-linear demodulators). For instance, the demodulator may use a relationship defined by the equation,

$${L}_{PAS} ( i ) = ln ( \frac{{\sum }_{x ∈ {ℳ}_{0 , i}} P ( x ) p ( y \vert x )}{{\sum }_{x ∈ {ℳ}_{1 , i}} P ( x ) p ( y \vert x )} ) ,$$

where L_{PAS}(i) may refer to an LLR corresponding to a bit i (e.g., which may be a target bit to compute for a demodulator), [symbol] _{0,i} and [symbol] _{1,i} may refer to a set of constellations (e.g., a subsets of QAM constellations) for which the ith bit is equal to 0 and 1, respectively. Further, P(x) may refer to the prior information of a particular modulation symbol x and p(y|x) may refer to the likelihood of the received signal given the modulation symbol x.

Further, a method of applying prior probability information may depend on details associated with the demodulator. For example, different methods may be used to add the constellation symbol prior probability information based on whether the demodulator is a linear minimum mean square error (LMMSE) demodulator, a non-linear demodulator, a sphere-decoding demodulator, and so on. Such dependency may introduce additional complexity and may result in significant increases in evaluation and verification efforts to support PAS demodulation in addition to demodulating uniform QAM. Moreover, each change (e.g., feature update) to a MIMO demodulator may result in further testing and verification to ensure functionality for both uniform QAM demodulation and PAS demodulation. Some example features (e.g., that may be updated over time) may include dynamic switching between linear and non-linear demodulation, decimation, early termination, distance approximation, subset size selection, among other examples. Such challenges may call for a simpler scheme to account for probabilistic shaping signals that are agnostic of the demodulator.

For single-input single-output (SISO) systems, some techniques may be used to separates a contribution of PAS processing from QAM demodulation procedures (e.g., which may be associated with a distance computation for MB prior probability information, \sqrt{−log Pr(x)}=\sqrt{v}|x|). Such techniques may support a scaling of the received signal, the noise power, and the channel estimate, and then may reuses a same demodulator (e.g., for LLR computation) as uniform QAM. Further, applying such techniques (e.g., SISO techniques) separately for each layer of a MIMO signal may not support independent preprocessing from the demodulator. Accordingly, techniques may be desired to that process the PAS prior information independently from the demodulator.

The wireless communications system 100 and the devices therein (e.g., a UEs 115, a network entity 105, a DU 165, a CU 160, an RU 170, among other examples) may utilize multi-layer communication schemes, such as MIMO communication schemes. Further the devices of the wireless communications system 100 may utilize probabilistic shaping techniques (e.g., PAS techniques) in which modulated symbols use non-uniform probability. However, the integration of probabilistic shaping into the wireless communications system 100 may further increase complexity resulting in increased power consumption, increased latency, and reduced communication quality, among other effects. In accordance with aspects described herein, one or more devices of the wireless communications system 100 may support one or more probabilistic shaping techniques that include preprocessing a multi-layer signal (e.g., MIMO signals) prior to demodulation. In some examples, based on receiving a multi-layer signal (e.g., MIMO signal), the device(s) may apply one or more probabilistic shaping parameters to the signal resulting in a preprocessed signal and a preprocessed channel estimate. Such preprocessed information may be used by a demodulator of the device to generate an estimate of the received signal. By separating the effect of probabilistic shaping on the received signal from the demodulation process, the wireless device(s) may utilize relatively simpler demodulation components, which may achieve improved performance, reduced power consumption, and increased system capacity, among other benefits.

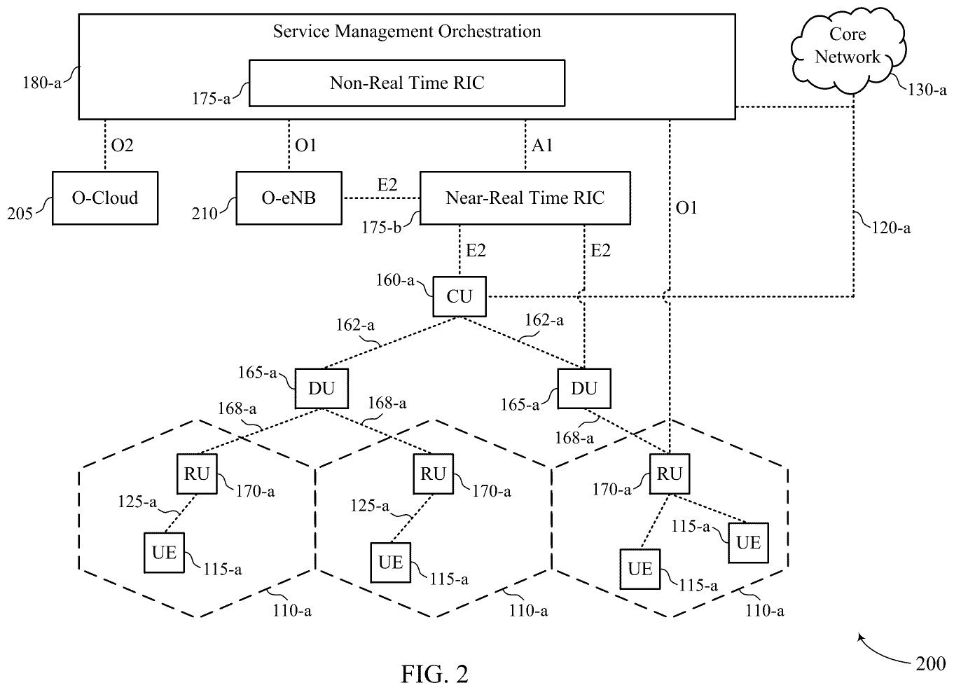

FIG. 2 shows an example of a network architecture 200 (e.g., a disaggregated base station architecture, a disaggregated RAN architecture) that supports probabilistic shaping and signal demodulation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The network architecture 200 (including any of the devices therein) may utilize multi-layer communication schemes, such as MIMO communication schemes. Further, the devices of network architecture 200 may utilize probabilistic shaping techniques (e.g., PAS techniques) in which modulated symbols use non-uniform probability. However, the integration of probabilistic shaping into the network architecture 200 may increase complexity resulting in increased power consumption, increased latency, and reduced communication quality. Thus, as described herein, one or more devices (e.g., a UEs 115, a DU 165, a CU 160, an RU 170, among other examples) of the network architecture 200 may support one or more probabilistic shaping and demodulation techniques that include preprocessing a multi-layer signal (e.g., MIMO signals) prior to demodulation. In some examples, based on receiving a multi-layer signal (e.g., MIMO signal), the device(s) may apply one or more probabilistic shaping parameters to the signal resulting in a preprocessed signal and a preprocessed channel estimate. Such preprocessed information may be used by a demodulator of the device to generate an estimate of the received signal. By separating the effect of probabilistic shaping on the received signal from the demodulation process, the device(s) or components of the network architecture 200 may utilize relatively simpler demodulation components, which may achieve improved performance, reduced power consumption, and increased system capacity, among other benefits.

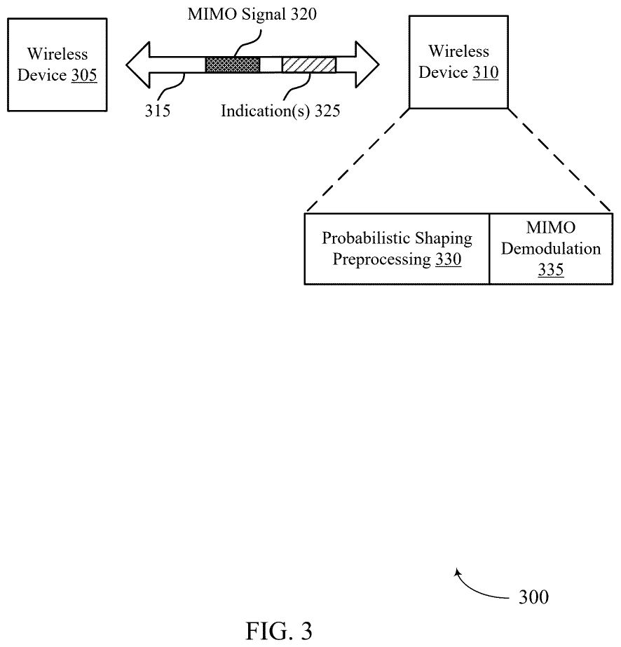

FIG. 3 shows an example of a wireless communications system 300 that supports probabilistic shaping and signal demodulation in accordance with one or more aspects of the present disclosure. The wireless communications system 300 may implement or be implemented by aspects of the wireless communications system 100 or the network architecture 200 as described with reference to FIGS. 1 and 2. For example, the wireless communications system 300 may include a wireless communication device 305 (e.g., an encoding device, a transmitter) and a wireless communication device 310 (e.g., an decoding device, a receiver), which may be examples of, or include a network entity 105, a UEs 115, a CU 160, a DU 165, a RU 170, or other devices as described with reference to FIGS. 1 and 2. The wireless communication device 305 may communicate with the wireless communication device 310 via a communication link 315 (e.g., a sidelink interface, a downlink interface, an uplink interface). In some examples, the wireless communication device 305 and the wireless communication device 310 may support one or more techniques herein that enable performance of probabilistic shaping preprocessing 330 and MIMO demodulation 335 of a MIMO signal 320 (e.g., or other signaling associated with multiple spatial layers or independent data streams).

In some cases, to support system capacity and data throughput improvements, the devices of the wireless communications system 300 may utilize probabilistic shaping techniques (e.g., PAS) to modulate information bits (e.g., or information symbols) using non-uniform probability (e.g., using QAM constellations with non-uniform amplitudes). For instance, a probability associated with an amplitude and/or a sign of a modulation symbol may be different among a set of multiple symbols of a wireless communication message. Such techniques may increase communication reliability between the wireless communication device 305 and the wireless communication device 310. However, the integration of probabilistic shaping into systems that support MIMO communications (e.g., of MIMO signals 320) may increase complexity at the wireless communication device 310 (e.g., the decoding device). For example, demodulation processes at that wireless communication device 310 may not support demodulation of MIMO signals 320, which may limit the system capacity and increase latency in the wireless communications system 300.

In accordance with one or more techniques described herein, the wireless communication device 310 (e.g., and the wireless communication device 305) may be enabled to demodulate probabilistic shaping signals (e.g., PAS signals) in MIMO signals 320. A MIMO signal 320 may be a communication signal that is associated with multiple layers (e.g., spatial layers, data streams), where at least one layer is modulated based on probabilistic shaping techniques (e.g., a PAS MIMO signal). In some examples, the wireless communication device 310 may support one or more processing (e.g., preprocessing) procedures that are performed on the MIMO signals 320 and account for probabilistic shaping information (e.g., PAS prior probability information, power scaling information). Such processing may be referred to as “preprocessing” (e.g., probabilistic shaping preprocessing 330) due to the processing being performed prior to a demodulation procedure at the wireless communication device 310 (e.g., processing performed outside the demodulator, MIMO demodulation 335).

In some examples, the wireless communication device 310 may separate handling probabilistic shaping information (e.g., probabilistic shaping preprocessing 330) from the demodulator (e.g., MIMO demodulation 335). For example, the wireless communication device 310 may receive a MIMO signal 320 and may obtain one or more channels estimates (e.g., one or more metrics associated with a channel over which the MIMO signal 320 was communicated). The wireless communication device 310 may also receive one or more probabilistic shaping parameters (e.g., PAS parameters, via an indication 325 from a wireless communication device 305). As part of probabilistic shaping preprocessing 330, the wireless communication device 310 may apply the probabilistic shaping parameters to the MIMO signal 320 (e.g., a vector or matrix, y) and the channel estimates (e.g., a vector or matrix, H).

As a result of the probabilistic shaping preprocessing 330, the wireless communication device 310 may obtain a preprocessed signal (e.g., a vector or matrix, \tilde{y}) and a preprocessed channel estimate (e.g., a vector or matrix, H). The wireless communication device 310 may input the preprocessed signal and the preprocessed channel estimate to a demodulator (e.g., a uniform QAM MIMO demodulator), which may produce one or more decoding metrics (e.g., one or more LLRs) that may be used to generate (e.g., produce, compute, determine, calculate) an estimate of the MIMO signal 320 and thereby decode the MIMO signal 320.

The preprocessed signal and the preprocessed channel may include (e.g., be integrated with) probabilistic shaping information and may also exhibit characteristics of a uniformly modulated signal (e.g., a symbol associated with a uniform distribution of bit probabilities). That is, the wireless communication device 310 may utilize a uniform demodulator (e.g., uniform QAM MIMO demodulator) to perform the MIMO demodulation 335 based on performing the probabilistic shaping preprocessing 330. Accordingly, enhancements made to the uniform demodulation process may be directly applied for probabilistic shaping signals (e.g., PAS signal) without alternation and/or parameter tuning. Moreover, in some examples, the separate signal preprocessing and other techniques described herein may yield a performance improvement over other demodulator designs (e.g., designs that integrate the probabilistic shaping information handling inside the demodulator). The techniques described herein may also be applicable for various signal shaping schemes (e.g., including the non-shaping, a shaping rate=1 case) and/or various modulation orders.

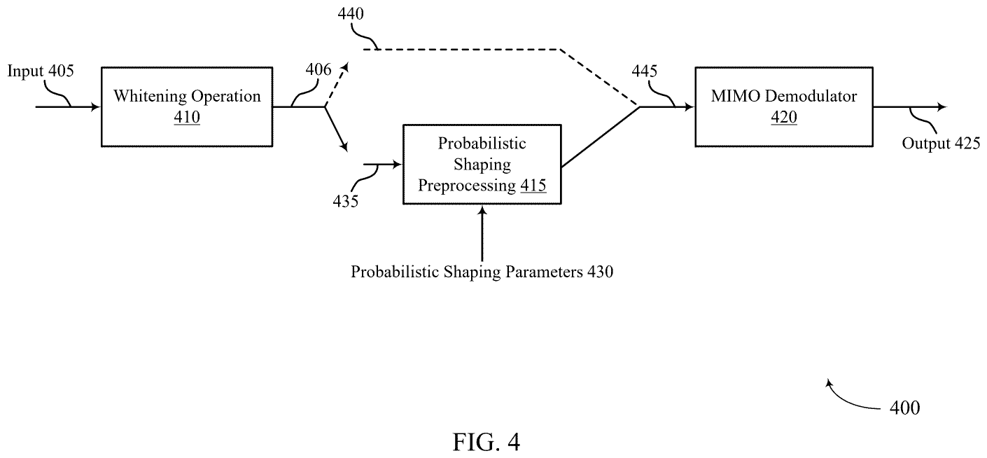

FIG. 4 shows an example of a processing diagram 400 that supports probabilistic shaping and signal demodulation in accordance with one or more aspects of the present disclosure. In some examples, a wireless communication device (e.g., a network entity 105, a UEs 115, a CU 160, a DU 165, a RU 170, a wireless communication device 305, a wireless communication device 310, or other device as described with reference to FIGS. 1-3) may apply one or more aspects of the processing diagram 400 to perform probabilistic shaping preprocessing (e.g., probabilistic shaping preprocessing 330) and MIMO demodulation (e.g., MIMO demodulation 335).

Throughout the description herein, the processing diagram 400 may be described with reference to equations, matrix operations, mathematical notation, and other notation. For example, the described techniques may be described in terms of a MIMO communication system with an input-output relationship described by Equation 1.

$$y = H \cdot D \cdot x + n \qquad ( 1 )$$

In Equation 1, y may represent (e.g., denote) a received signal (e.g., a communication signal) across all receive antennas (e.g., as a vector of entries, where a quantity of entries corresponds to a quantity of signals or layers), H may represent the channel (e.g., a pre-coded channel, a channel estimate) corresponding to each pair of transmission layer and receive antenna (e.g., as a matrix, where a quantity of rows in the matrix corresponds to a quantity of receive antennas and a quantity of columns in the matrix corresponds to a quantity of transmission layers), and D may represent a diagonal matrix, D=diag{\sqrt{η₁}, . . . , =\sqrt{η_{L}}}, where ηᵢ may represent an additional power scaling (e.g., a power scaling parameter) on layer i for probabilistic shaping (e.g., PAS) relative to a uniform QAM with a same constellation set, such that the average power E[η|xᵢ|²]=1 when averaged with respect to a probability distribution of xᵢ on layer i (e.g., for uniform QAM, η=1). In some examples, the magnitude of xᵢ may be selected such that

$$\frac{1}{M} {\sum }_{i} {\vert {x}_{i} \vert}^{2} = 1.$$

Further, x may represent an input signal to be demodulated (e.g., detected, as a vector of entries), and n may represent the interference plus noise (e.g., Gaussian noise) with covariance R_{NN}. Additionally, or alternatively, a parameter, V may represent a diagonal matrix, V=diag{v₁, . . . , v_{L}}, where vᵢ may contain a MB parameter (e.g., a prior probability, probabilistic shaping probability metric, probability distribution parameter) used for the signal (e.g., y) in layer i. In other words, Pr(xᵢ=s)∝e^{-v|s|}^{²}, where's∈Sᵢ and Sᵢ may represent the set of constellation points on layer i. In some examples, for uniform QAM, v may be set as v=0. That is, the wireless communication device may determine that a subset of the layers (e.g., at least one layer) are not associated with probabilistic shaping (e.g., PAS) and may set one or more probability distribution parameters to a value equal to 0 for the subset of layers.

In some examples, a communication signal, a channel estimate, and a noise plus interference covariance (e.g., y, H, and R_{NN}) may be received (e.g., presented) at the input 405, and the wireless communication device may perform a whitening operation 410 based on the input 405. That is, an input interface of the whitening operation 410 may accept (e.g., obtain) one or more signals including the communication signal, the channel estimate, the noise plus interference covariance, or any combination thereof. The whitening operation 410 may be used to whiten the signal y and channel estimate H such that the effective noise plus interference is associated with white noise (e.g., exhibiting the properties of white noise). In some examples, for the channel estimate H, the communication signal y, and noise plus interference covariance R_{NN}, the whitened channel estimate may represented by H_{wh} and the whitened signal may be represented by y_{wh}, which may be respectively defined as H_{wh}=L·H and y_{wh}=L·y, where L may represent an inverse Cholesky decomposition of

$${R}_{NN} ( e . g . , {L}^{H} L = {R}_{NN}^{- 1} ) .$$

At 406 (e.g., an output of the whitening operation 410), the communication signal and the channel estimate (e.g., the whitened signal and channel estimate, y_{wh} and H_{wh}) may be output to a path 435 or a path 440. That is, an output interface of the whitening operation 410 may output one or more signals including the communication signal, the channel estimate (e.g., the whitened signal and the whitened channel estimate), or both, which may be received (e.g., accepted, obtained) by an input interface of the probabilistic shaping preprocessing 415. In some examples, outputting y_{wh} and H_{wh} may be based on whether the received signal y is associated with probabilistic shaping. In some examples, the wireless communication device may receive an indication of whether the received signal is associated (e.g., in at least one layer) with probabilistic shaping. For example, when probabilistic shaping (e.g., PAS) is enabled at a transmitter (e.g., for at least one of the layers in the MIMO transmission) the receiver may use a probabilistic shaping preprocessing 415 (e.g., the path 435 to process the signal y_{wh} and channel estimate H_{wh} prior to processing with the MIMO demodulator 420 (e.g., a uniform QAM demodulator). Thus, the probabilistic shaping preprocessing 415 may embed the probabilistic shaping information (e.g., PAS prior information) into the signal such that, when passed through the MIMO demodulator 420, the probabilistic shaping information is accurately captured. Accordingly, the probabilistic shaping processing may be decoupled from a demodulation algorithm.

Alternatively, the wireless communication device may identify (e.g., receive indication of, determine, detect) that the signal (e.g., including each layer of the signal) is not associated with probabilistic shaping (e.g., is a uniform QAM signal). In such scenarios, the wireless communication device may output the data to the path 440, which may bypass the probabilistic shaping preprocessing 415 and may be input directly to the MIMO demodulator 420.

The probabilistic shaping preprocessing 415 (e.g., PAS preprocessing) may be performed after the whitening operation 410 and before the MIMO demodulator 420. Additionally, or alternatively, the whitening operation 410 and the probabilistic shaping preprocessing 415 may performed jointly. For example, when PAS is enabled in one of the layers, the whitening operation 410 and the probabilistic shaping preprocessing 415 may be performed together (e.g., at least partially), and when PAS is not enabled in any of the layers, the whitening operation 410 may be performed without the probabilistic shaping preprocessing 415. The probabilistic shaping preprocessing 415 may be associated with applying one or more probabilistic shaping parameters 430 (e.g., D, V) to the signal y_{wh} and channel estimate H_{wh}. The probabilistic shaping preprocessing 415 may be associated with one or more matrix decomposition operations. For example, the wireless communications device may perform a QR decomposition operation, which may be written as Equation 2.

$$[ \begin{matrix}{Q}_{1} \\ {Q}_{2}\end{matrix} ] \cdot R = [ \begin{matrix}{DH}_{wh} \\ {V}^{- 1 / 2}\end{matrix} ] \qquad ( 2 )$$

That is, in equation 2, Q₁R=DH_{wh},

$${Q}_{2} R = {V}^{- \frac{1}{2}} ,$$

V may be a diagonal matrix, and

$${R}^{H} R = {DH}_{wh}^{H} {H}_{wh} D + V ,$$

where K may be an upper triangular matrix. Further, Q₁^{H}Q₁+Q₂^{H}Q₂=I, where I represents an identity matrix. That is, Q₁ and Q₂ may be orthogonal matrices. The matrix,

$$[ \begin{matrix}{DH}_{wh} \\ {V}^{- 1 / 2}\end{matrix} ] ,$$

may be obtained by combining (e.g., stacking, concatenating) the channel matrix H_{wh} and a second matrix that includes the one or more probabilistic shaping parameters 430. Subsequently, a preprocessed signal (which may be represented by \tilde{y}) and a preprocessed channel estimation (which may be represented by \tilde{H}) may be computed (e.g., determined, generated, calculated) based on the decomposition. For example, the preprocessed signal may be determined in accordance with the equation

$$\tilde{y} = {Q}_{1}^{H} {y}_{wh} ,$$

and the preprocessed channel estimate may be determined in accordance with the equation \tilde{H}=R. In some examples, such a QR decomposition may not be performed for each tone, and may be performed once for multiple tones (e.g., within the channel coherence bandwidth).

Additionally, or alternatively, the matrix decomposition operations of the probabilistic shaping preprocessing 415 may be a Cholesky decomposition operation. For example, a first operation may include computing a matrix R_{H,v} based on the equation

$${R}_{H , v} = {DH}_{wh}^{H} {H}_{wh} D + V .$$

second operation may include performing Cholesky decomposition on R_{H,v} as R^{H}R=R_{H,v}. A third operation may include computing the preprocessed signal \tilde{y} based on the equation

$$\tilde{y} = {RR}_{Hv}^{- 1} {DH}_{wh}^{H} {y}_{wh} .$$

Subsequently, the preprocessed signal \tilde{y} and the preprocessed channel estimate \tilde{H} (e.g., \tilde{H}=R) may be sent to the MIMO demodulator 420.

The preprocessed signal \tilde{y} and the preprocessed channel \tilde{H} (e.g., computed in accordance with the probabilistic shaping preprocessing 415) may be input to a MIMO demodulator 420. The MIMO demodulator 420 may, in some examples, be a uniform QAM MIMO demodulator. That is, the MIMO demodulator 420 may expect that its inputs are associated with a uniform probability distribution and may execute its processing and algorithms as such. Thus, the probabilistic shaping preprocessing 415 may process the signal y (e.g., and the channel estimate H) such that the resulting preprocessed signal \tilde{y} (e.g., and the preprocessed channel estimate \tilde{H}) appears at an input 445 of the MIMO demodulator 420 as a signal associated with uniformly distributed signal. That is, an output interface of the probabilistic shaping preprocessing 415 may output one or more signals including the preprocessed signal (e.g., \tilde{y}), the preprocessed channel (e.g., \tilde{H}), or both, which may be received (e.g., accepted, obtained) at an input interface of the MIMO demodulator 420. Based on such inputs, the MIMO demodulator 420 may generate an estimate of the signal y (e.g., x) at an output 425. In some examples, an output interface of the MIMO demodulator may output one or more signals including the estimate of the output signal, one or more LLRs (e.g., associated with the estimated signal), or both. The generation may be based on computing (e.g., determine, calculate) an LLR for each coded bit of the signal y. In some examples, the MIMO demodulator 420 may perform its operations based on an assumption that the noise is white or has been whitened by the whitening operation 410.

In some examples, the MIMO demodulator 420 for uniform QAM demodulation may be associated with computation of one or more distance metrics, which may be computed based on the equation D (x)=∥y−Hx∥². Here, x may represent a vector of candidate QAM symbols on all L layers. In some examples, a machine learning demodulator may compute the distances for all M₁, M₂, . . . , M_{L} possible candidate QAM combinations and make log-maximum a posteriori (log-MAP) decisions. Further, in PAS scenarios, the distance metrics may be computed based on the equation D_{PAS}(x)=∥y−H·Dx∥²−log Pr(x). As such, the distance metric D_{PAS}(x) may be computed by a uniform QAM demodulator (e.g., the MIMO demodulator 420). That is, use of a uniform QAM demodulator may be enabled based on an assumption that represented by the equation

$${D}_{PAS} ( x ) = {‖ {Q}_{1}^{H} y - Rx ‖}^{2} + constant ( y ) ,$$

and such an equation may be justified based on the following chain of Equations 3a through 3e (e.g., where Equation 3e follows because log Pr(x)=−Σvᵢ|xᵢ|²=−x^{H}Vx).

$${‖ {Q}_{1}^{H} y - Rx ‖}^{2} = ( {y}^{H} {Q}_{1} - {x}^{H} {R}^{H} ) ( {Q}_{1}^{H} y - Rx ) \qquad ( 3 a )$$

$$= {y}^{H} {Q}_{1} {Q}_{1}^{H} y - {x}^{H} {R}^{H} {Q}_{1}^{H} y - {y}^{H} {Q}_{1} R x + {x}^{H} {R}^{H} Rx \qquad ( 3 b )$$

$$= constant ( y ) - {x}^{H} {H}^{H} Dy - {y}^{H} DHx + {x}^{H} ( {DH}^{H} HD + V ) x \qquad ( 3 c )$$

$$= constant ( y ) + {D}_{PAS} ( x ) + {x}^{H} Vx + log Pr ( x ) \qquad ( 3 d )$$

$$= constant ( y ) + {D}_{PAS} ( x ) \qquad ( 3 e )$$

Although, one or more techniques herein are described in terms of MIMO signaling, such techniques are not limited to MIMO signaling scenarios. That is, the described techniques may apply for other scenarios that may be reduced to a MIMO channel (e.g., or represented using matrix mechanisms similar to MIMO systems, any system represented as a linear combination of multiple streams). For example, for a DFT-S-OFDM system, there may be inter signal interference (ISI) in a time domain, and the received signal may be equivalently written as Y=diag{hᵢ}·F·x+noise, where x may represent the modulation symbols prior to a DFT transform, F may represent the DFT matrix, and diag{hᵢ} may be a diagonal matrix that contains the channel coefficients in a frequency domain, and Y may represent the received signal in the frequency domain. In such examples, the term diag{hᵢ}·F may be treated as the channel matrix, and the described techniques for probabilistic shaping preprocessing 415 and demodulation may apply for such scenarios.

By applying one or more techniques described herein, a wireless communication system may support various improvements including increased system capacity and increased data rates. For example, in a PAS scenario (e.g., and/or for non-linear receivers or sphere-decoding receivers), the wireless communication system may experience performance gains (e.g., of 3 dB or more) compared to uniform QAM at a same spectral efficiency (e.g., and a channel at 10⁻¹ block error rate (BLER) or 10⁻² BLER). Furter, additional gains may be obtained based on using the described techniques, which may be associated with a universal method with respect to demodulation types as well as various combinations of signaling schemes (e.g., PAS+uniform QAM, different PAS rates at different layers).

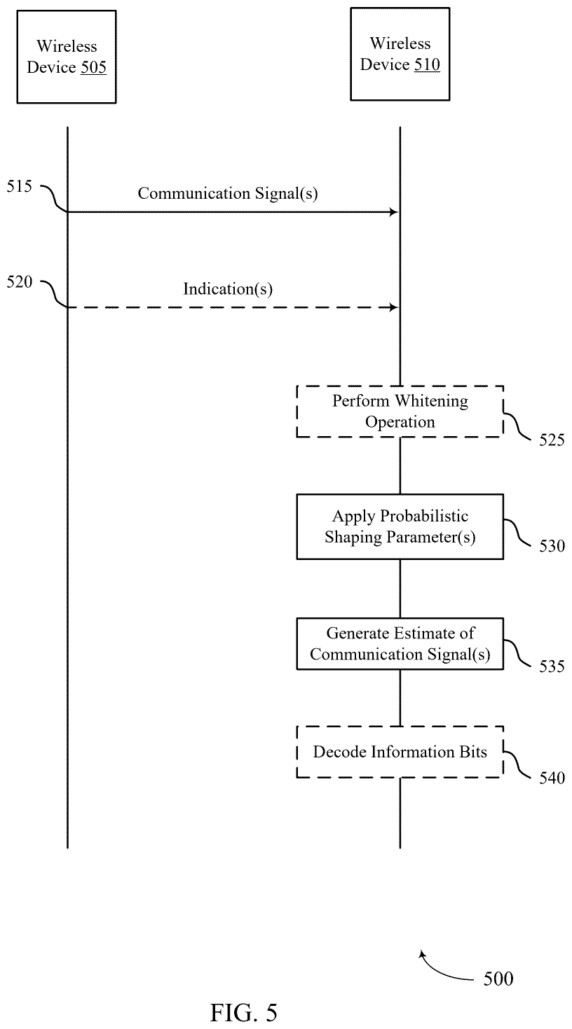

FIG. 5 shows an example of a process flow 500 that supports probabilistic shaping and signal demodulation in accordance with one or more aspects of the present disclosure. The process flow 500 may implement or be implemented to realize aspects of the wireless communications system 100, the network architecture 200, or the 300//. For example, the process flow 500 illustrates communication between a wireless communication device 505 and a wireless communication device 510, which may be examples of corresponding devices described herein, including as described with reference to FIGS. 1-4. Alternative examples of the following may be implemented. Some steps may be performed in a different order than described or are not performed at all. In some implementations, steps may include additional features not mentioned below, or further steps may be added. Further, although some operations or signaling may be shown to occur at different times for discussion purposes, these operations may actually occur at the same time.

At 515, a wireless communication device 510 (e.g., receiver device, decoder device, demodulating device) may receive a communication signal (e.g., a MIMO signal 320, y) that includes a set of multiple layers. In some examples, at least one layer of the set of layers may be associated with a probabilistic shaping signal (e.g., a PAS signal). The communication signal may be transmitted by a wireless communication device 505 (e.g., an encoding device, a modulating device).

At 520, the wireless communication device 510 may receive (e.g., from the wireless communication device 505) an indication of one or more probabilistic shaping parameters (e.g., D, V), and the wireless communication device 510 may apply the parameters based on (e.g., in response to receiving) the indication. In some examples, the wireless communication device 510 may also receive an indication that at least one layer of the set of multiple layers is associated with the probabilistic shaping signal and may apply the one or more probabilistic shaping parameters based on the indication.

In some examples, the wireless communication device 510 may receive an indication (e.g., or otherwise determine or detect) that the layers of the communication signal are not associated with a probabilistic shaping signal (e.g., non-PAS signals). Accordingly, the wireless communication device 510 may input the communication signal and a channel estimate to a demodulator (e.g., a uniform QAM demodulator) of the wireless communication device 510 (e.g., thereby bypassing the probabilistic shaping preprocessing).

At 525, the wireless communication device 510 may perform a whitening operation (e.g., a whitening operation 410) on the communication signal and/or a channel estimate (e.g., H), which may occur prior to applying the one or more probabilistic shaping parameters to the communication signal. In some examples, the whitening operation may convert noise associated with the communication signal to white noise (e.g., may generate y_{wh} and H_{wh}).

At 530, the wireless communication device 510 may apply one or more probabilistic shaping parameters (e.g., D, V) to the communication signal to obtain a preprocessed signal (e.g., \tilde{y}). The preprocessed signal may include probability information (e.g., may be embedded with prior probability information) associated with the probabilistic shaping signal based on the one or more probabilistic shaping parameters (e.g., and application thereof). In some examples, the one or more probabilistic shaping parameters may include various sets of parameters each associated with respective signal layers. For example, the one or more parameters may include one or more first probabilistic shaping parameters and one or more second probabilistic shaping parameters. The wireless communication device 510 may apply the one or more first probabilistic shaping parameters to a first layer of the set of layers and may apply the one or more second probabilistic shaping parameters to a second layer of the set of layers that is different than the first layer. In some examples, the wireless communication device 510 may apply the one or more probabilistic shaping parameters to a channel estimate (e.g., H) to obtain a preprocessed channel estimate (e.g., H). The channel estimate may be associated with a channel over which the communication signal is received from the wireless communication device 505, and an estimate of the communication signal may be generated based on the preprocessed channel estimate.

In some examples, the wireless communication device 510 may perform one or more matrix decomposition operations (e.g., as part of the application of the probabilistic shaping parameters). The wireless communication device 510 may perform such operations on one or more matrices to obtain the preprocessed signal and the preprocessed channel estimate. For example, a matrix (e.g., for the decomposition operation,

$$[ \begin{matrix}{DH}_{wh} \\ {V}^{- 1 / 2}\end{matrix} ] , {DH}_{wh}^{H} {H}_{wh} D + V )$$

may include a channel estimate (e.g., H), one or more power scaling parameters associated with the set of layers (e.g., D), and one or more probability distribution parameters (e.g., V) associated with the set of layers, or a combination thereof. The wireless communication device 510 may obtain (e.g., formulate, create, generate) the matrix based on combining (e.g., stacking, concatenating) a first matrix including the channel estimate and a second matrix including the one or more power scaling parameters and the one or more probability distribution parameters. The matrix decomposition operation may include decomposing the matrix into a third matrix (e.g., R) and a fourth matrix

$$( e . g . , [ \begin{matrix}{Q}_{1} \\ {Q}_{2}\end{matrix} ] , {RR}_{Hv}^{- 1} {DH}_{wh}^{H} {y}_{wh} ) .$$

In some examples, the third matrix may include the preprocessed channel estimate (e.g., \tilde{H}=R) and the fourth matrix may include one or more orthogonal matrices (e.g., Q₁, Q₂). The wireless communication device 510 may apply the fourth matrix to the communication signal to obtain the preprocessed signal. The matrix decomposition operation may be associated with a QR decomposition operation, a Cholesky decomposition operation, or both.

In some examples, the wireless communication device 510 may determine that at least one second layer of the set of layers is not associated with a probabilistic shaping signal. Accordingly, the wireless communication device 510 may set a parameter of the one or more probabilistic shaping parameters associated with the at least one second layer to a value equal to 0 (e.g., v=0) based on the determination. As such, generating an estimate of the communication signal may be based on setting the parameter to a value equal to 0.

At 535, the wireless communication device 510 may generate an estimate of the communication signal based on the preprocessed signal. In some examples, to generate the estimate, the wireless communication device 510 may input the preprocessed signal and the preprocessed channel estimate to a uniform QAM demodulator (e.g., MIMO demodulator 420) of the wireless communication device 510. The uniform QAM demodulator may generate the estimate of the communication signal based on the preprocessed signal and the preprocessed channel estimate.

At 540, the wireless communication device 510 may decode the one or more information bits based on generating the estimate of the communication signal. For example, the demodulator may output (e.g., produce, generate, compute) one or more LLRs for one or more information bits associated with the communication signal, and the wireless communication device 510 may decode the information bits (e.g., and generate the estimate) based on the LLRs.

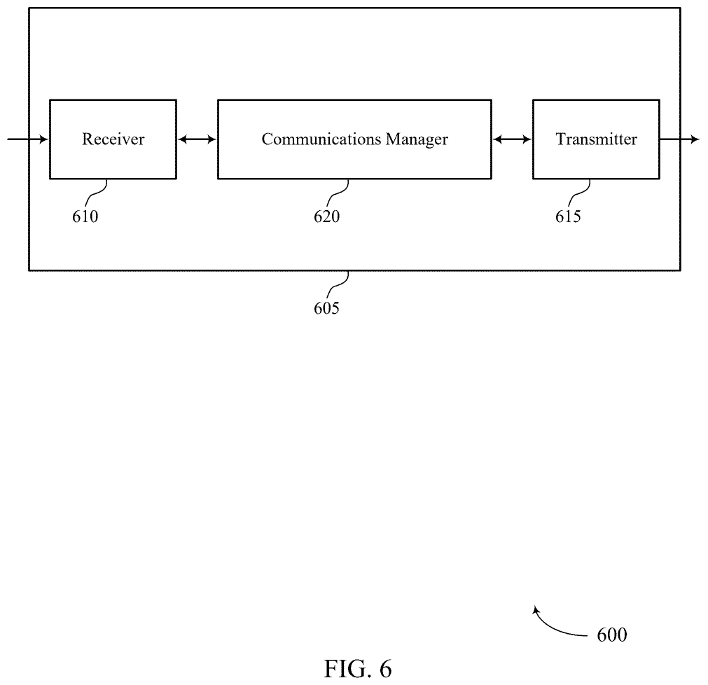

FIG. 6 shows a block diagram 600 of a device 605 that supports probabilistic shaping and signal demodulation in accordance with one or more aspects of the present disclosure. The device 605 may be an example of aspects of a wireless communication device as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to probabilistic shaping and signal demodulation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to probabilistic shaping and signal demodulation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of probabilistic shaping and signal demodulation as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a communication signal that includes a set of multiple layers, where at least one layer of the set of multiple layers is associated with a probabilistic shaping signal. The communications manager 620 is capable of, configured to, or operable to support a means for applying one or more probabilistic shaping parameters to the communication signal to obtain a preprocessed signal, where the preprocessed signal includes probability information associated with the probabilistic shaping signal based on the one or more probabilistic shaping parameters. The communications manager 620 is capable of, configured to, or operable to support a means for generating, subsequent to applying the one or more probabilistic shaping parameters, an estimate of the communication signal based on the preprocessed signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other benefits.

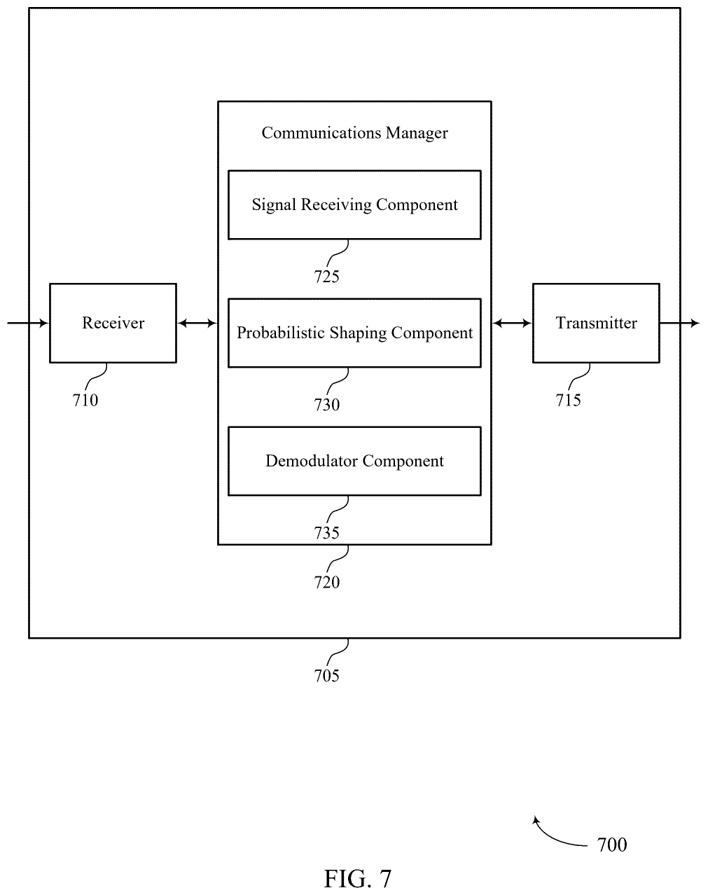

FIG. 7 shows a block diagram 700 of a device 705 that supports probabilistic shaping and signal demodulation in accordance with one or more aspects of the present disclosure. The device 705 may be an example of aspects of a device 605 or a wireless communication device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to probabilistic shaping and signal demodulation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to probabilistic shaping and signal demodulation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of probabilistic shaping and signal demodulation as described herein. For example, the communications manager 720 may include a signal receiving component 725, a probabilistic shaping component 730, a demodulator component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The signal receiving component 725 is capable of, configured to, or operable to support a means for receiving a communication signal that includes a set of multiple layers, where at least one layer of the set of multiple layers is associated with a probabilistic shaping signal. The probabilistic shaping component 730 is capable of, configured to, or operable to support a means for applying one or more probabilistic shaping parameters to the communication signal to obtain a preprocessed signal, where the preprocessed signal includes probability information associated with the probabilistic shaping signal based on the one or more probabilistic shaping parameters. The demodulator component 735 is capable of, configured to, or operable to support a means for generating, subsequent to applying the one or more probabilistic shaping parameters, an estimate of the communication signal based on the preprocessed signal.

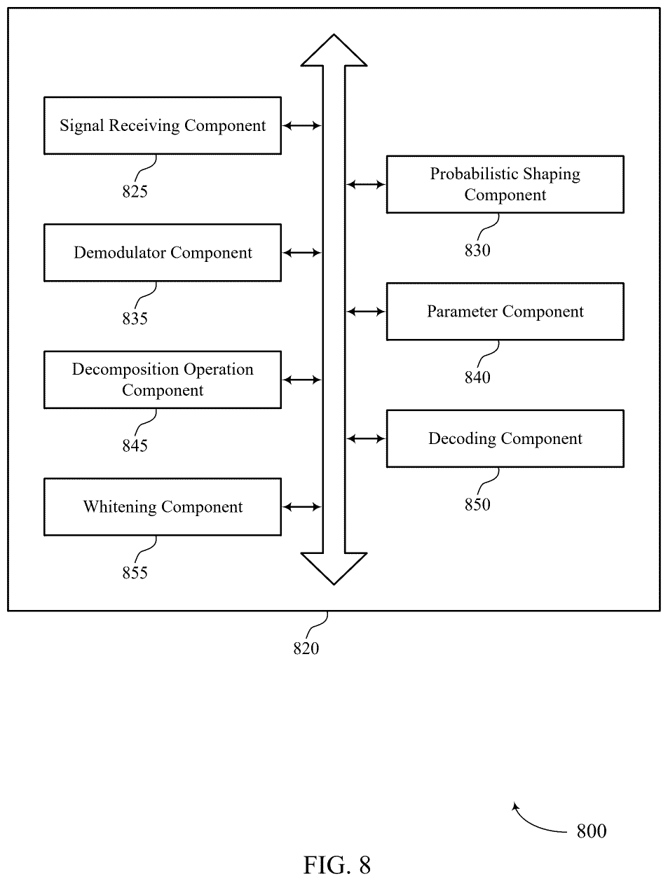

FIG. 8 shows a block diagram 800 of a communications manager 820 that supports probabilistic shaping and signal demodulation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of probabilistic shaping and signal demodulation as described herein. For example, the communications manager 820 may include a signal receiving component 825, a probabilistic shaping component 830, a demodulator component 835, a parameter component 840, a decomposition operation component 845, a decoding component 850, a whitening component 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The signal receiving component 825 is capable of, configured to, or operable to support a means for receiving a communication signal that includes a set of multiple layers, where at least one layer of the set of multiple layers is associated with a probabilistic shaping signal. The probabilistic shaping component 830 is capable of, configured to, or operable to support a means for applying one or more probabilistic shaping parameters to the communication signal to obtain a preprocessed signal, where the preprocessed signal includes probability information associated with the probabilistic shaping signal based on the one or more probabilistic shaping parameters. The demodulator component 835 is capable of, configured to, or operable to support a means for generating, subsequent to applying the one or more probabilistic shaping parameters, an estimate of the communication signal based on the preprocessed signal.

In some examples, the parameter component 840 is capable of, configured to, or operable to support a means for receiving an indication of the one or more probabilistic shaping parameters, where the one or more probabilistic shaping parameters are applied based on the indication.

In some examples, the parameter component 840 is capable of, configured to, or operable to support a means for receiving an indication that the at least one layer of the set of multiple layers is associated with the probabilistic shaping signal, where the one or more probabilistic shaping parameters are applied based on the indication.

In some examples, the one or more probabilistic shaping parameters include one or more first probabilistic shaping parameters and one or more second probabilistic shaping parameters, and, to support applying the one or more probabilistic shaping parameters, the probabilistic shaping component 830 is capable of, configured to, or operable to support a means for applying the one or more first probabilistic shaping parameters to a first layer of the set of multiple layers. In some examples, to support applying the one or more probabilistic shaping parameters, the probabilistic shaping component 830 is capable of, configured to, or operable to support a means for applying the one or more second probabilistic shaping parameters to a second layer of the set of multiple layers that is different than the first layer.

In some examples, the probabilistic shaping component 830 is capable of, configured to, or operable to support a means for applying the one or more probabilistic shaping parameters to a channel estimate to obtain a preprocessed channel estimate, where the channel estimate is associated with a channel over which the communication signal is received, and where the estimate of the communication signal is generated based on the preprocessed channel estimate.

In some examples, to support applying the one or more probabilistic shaping parameters to the communication signal, the decomposition operation component 845 is capable of, configured to, or operable to support a means for performing a matrix decomposition operation on a matrix to obtain the preprocessed signal and a preprocessed channel estimate, where the matrix includes a channel estimate, one or more power scaling parameters associated with the set of multiple layers, and one or more probability distribution parameters associated with the set of multiple layers, or a combination thereof.

In some examples, the decomposition operation component 845 is capable of, configured to, or operable to support a means for obtaining the matrix based on combining a first matrix including the channel estimate and a second matrix including the one or more power scaling parameters and the one or more probability distribution parameters. In some examples, the decomposition operation component 845 is capable of, configured to, or operable to support a means for decomposing the matrix into a third matrix and a fourth matrix, the third matrix including the preprocessed channel estimate and the fourth matrix including an orthogonal matrix. In some examples, the probabilistic shaping component 830 is capable of, configured to, or operable to support a means for applying the fourth matrix to the communication signal to obtain the preprocessed signal.

In some examples, the matrix decomposition operation includes a QR decomposition operation, a Cholesky decomposition operation, or both.

In some examples, the estimate of the communication signal includes one or more LLRs for one or more information bits associated with the communication signal, and the decoding component 850 is capable of, configured to, or operable to support a means for decoding the one or more information bits based on generating the one or more LLRs.

In some examples, to support generating the estimate of the communication signal, the demodulator component 835 is capable of, configured to, or operable to support a means for inputting the preprocessed signal and a preprocessed channel estimate to a uniform quadrature amplitude modulation (QAM) demodulator of the wireless communication device, where the uniform QAM demodulator generates the estimate of the communication signal based on the preprocessed signal and the preprocessed channel estimate.

In some examples, the signal receiving component 825 is capable of, configured to, or operable to support a means for receiving a second communication signal including a second set of multiple layers. In some examples, the probabilistic shaping component 830 is capable of, configured to, or operable to support a means for determining that the second set of multiple layers are not associated with a probabilistic shaping signal. In some examples, the demodulator component 835 is capable of, configured to, or operable to support a means for inputting the second communication signal and a channel estimate to the uniform QAM demodulator based on the determining. In some examples, the demodulator component 835 is capable of, configured to, or operable to support a means for generating a second estimate of the second communication signal based on the second communication signal and the channel estimate.

In some examples, the whitening component 855 is capable of, configured to, or operable to support a means for performing a whitening operation to the communication signal and a channel estimate prior to applying the one or more probabilistic shaping parameters to the communication signal, where the whitening operation converts noise associated with the communication signal to white noise.

In some examples, the demodulator component 835 is capable of, configured to, or operable to support a means for determining that at least one second layer of the set of multiple layers is not associated with a probabilistic shaping signal. In some examples, the parameter component 840 is capable of, configured to, or operable to support a means for setting a parameter of the one or more probabilistic shaping parameters associated with the at least one second layer to a value equal to 0 based at least in part on the determining, where generating the estimate of the communication signal is based at least in part on setting the parameter.

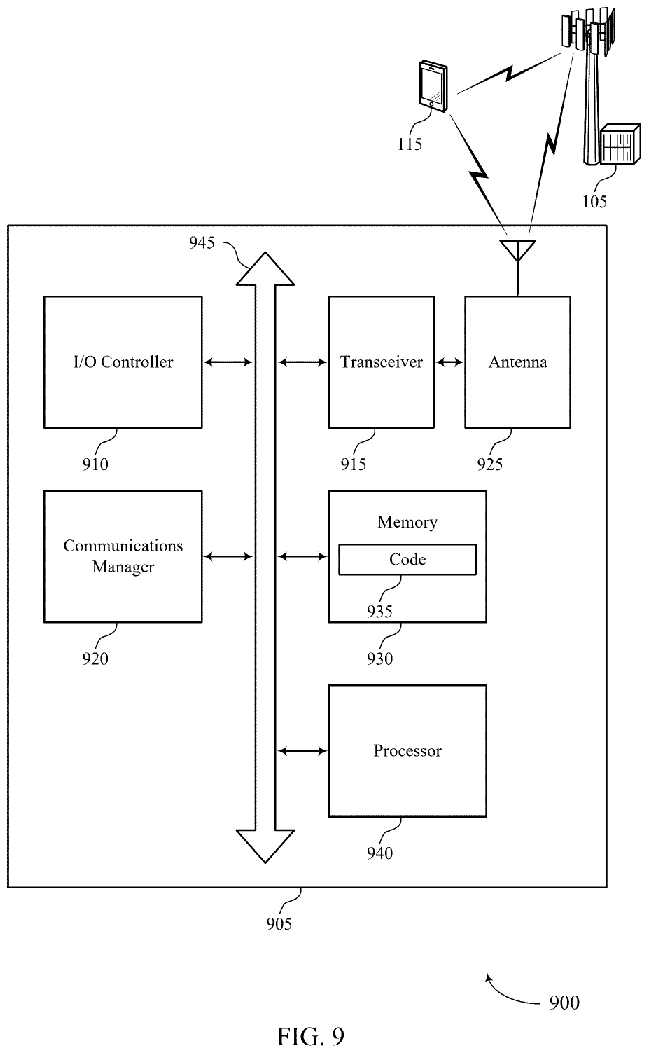

FIG. 9 shows a diagram of a system 900 including a device 905 that supports probabilistic shaping and signal demodulation in accordance with one or more aspects of the present disclosure. The device 905 may be an example of or include components of a device 605, a device 705, or a wireless communication device as described herein. The device 905 may include components for bi-directional voice and data communications including components for transmitting and receiving communications, such as a communications manager 920, an I/O controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include RAM and ROM. The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a BIOS which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting probabilistic shaping and signal demodulation). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a communication signal that includes a set of multiple layers, where at least one layer of the set of multiple layers is associated with a probabilistic shaping signal. The communications manager 920 is capable of, configured to, or operable to support a means for applying one or more probabilistic shaping parameters to the communication signal to obtain a preprocessed signal, where the preprocessed signal includes probability information associated with the probabilistic shaping signal based on the one or more probabilistic shaping parameters. The communications manager 920 is capable of, configured to, or operable to support a means for generating, subsequent to applying the one or more probabilistic shaping parameters, an estimate of the communication signal based on the preprocessed signal.

By including or configuring the communications manager 920 in accordance with examples as described herein, the device 905 may support techniques for improved communication reliability, reduced latency, improved user experience related to reduced processing and increased data throughput, reduced power consumption, longer battery life, improved utilization of processing capability, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of probabilistic shaping and signal demodulation as described herein, or the at least one processor 940 and the at least one memory 930 may be otherwise configured to, individually or collectively, perform or support such operations.

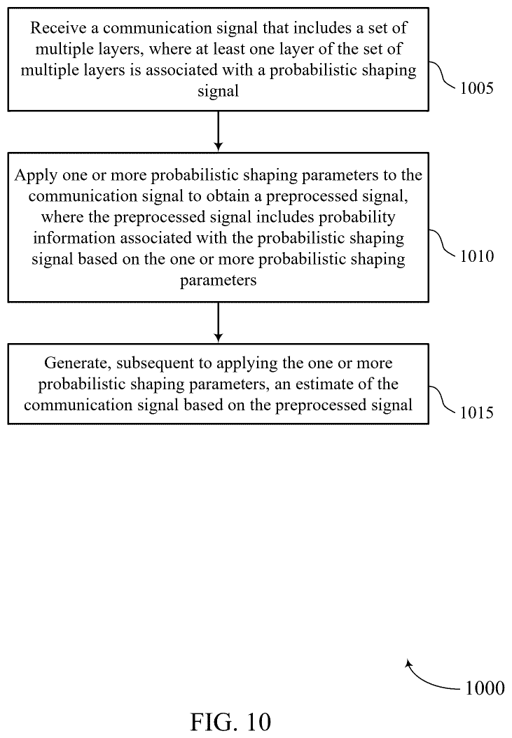

FIG. 10 shows a flowchart illustrating a method 1000 that supports probabilistic shaping and signal demodulation in accordance with one or more aspects of the present disclosure. The operations of the method 1000 may be implemented by a wireless communication device or its components as described herein. For example, the operations of the method 1000 may be performed by a wireless communication device as described with reference to FIGS. 1 through 9. In some examples, a wireless communication device may execute a set of instructions to control the functional elements of the wireless communication device to perform the described functions. Additionally, or alternatively, the wireless communication device may perform aspects of the described functions using special-purpose hardware.

At 1005, the method may include receiving a communication signal that includes a set of multiple layers, where at least one layer of the set of multiple layers is associated with a probabilistic shaping signal. The operations of 1005 may be performed in accordance with examples as disclosed herein. In some examples, aspects of the operations of 1005 may be performed by a signal receiving component 825 as described with reference to FIG. 8.

At 1010, the method may include applying one or more probabilistic shaping parameters to the communication signal to obtain a preprocessed signal, where the preprocessed signal includes probability information associated with the probabilistic shaping signal based on the one or more probabilistic shaping parameters. The operations of 1010 may be performed in accordance with examples as disclosed herein. In some examples, aspects of the operations of 1010 may be performed by a probabilistic shaping component 830 as described with reference to FIG. 8.

At 1015, the method may include generating, subsequent to applying the one or more probabilistic shaping parameters, an estimate of the communication signal based on the preprocessed signal. The operations of 1015 may be performed in accordance with examples as disclosed herein. In some examples, aspects of the operations of 1015 may be performed by a demodulator component 835 as described with reference to FIG. 8.

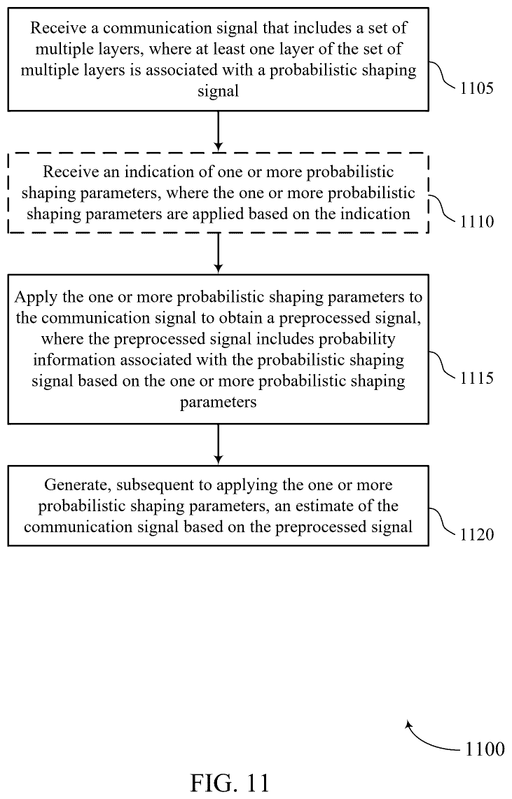

FIG. 11 shows a flowchart illustrating a method 1100 that supports probabilistic shaping and signal demodulation in accordance with one or more aspects of the present disclosure. The operations of the method 1100 may be implemented by a wireless communication device or its components as described herein. For example, the operations of the method 1100 may be performed by a wireless communication device as described with reference to FIGS. 1 through 9. In some examples, a wireless communication device may execute a set of instructions to control the functional elements of the wireless communication device to perform the described functions. Additionally, or alternatively, the wireless communication device may perform aspects of the described functions using special-purpose hardware.

At 1105, the method may include receiving a communication signal that includes a set of multiple layers, where at least one layer of the set of multiple layers is associated with a probabilistic shaping signal. The operations of 1105 may be performed in accordance with examples as disclosed herein. In some examples, aspects of the operations of 1105 may be performed by a signal receiving component 825 as described with reference to FIG. 8.

At 1110, the method may include receiving an indication of one or more probabilistic shaping parameters, where the one or more probabilistic shaping parameters are applied based on the indication. The operations of 1110 may be performed in accordance with examples as disclosed herein. In some examples, aspects of the operations of 1110 may be performed by a parameter component 840 as described with reference to FIG. 8.

At 1115, the method may include applying the one or more probabilistic shaping parameters to the communication signal to obtain a preprocessed signal, where the preprocessed signal includes probability information associated with the probabilistic shaping signal based on the one or more probabilistic shaping parameters. The operations of 1115 may be performed in accordance with examples as disclosed herein. In some examples, aspects of the operations of 1115 may be performed by a probabilistic shaping component 830 as described with reference to FIG. 8.

At 1120, the method may include generating, subsequent to applying the one or more probabilistic shaping parameters, an estimate of the communication signal based on the preprocessed signal. The operations of 1120 may be performed in accordance with examples as disclosed herein. In some examples, aspects of the operations of 1120 may be performed by a demodulator component 835 as described with reference to FIG. 8.

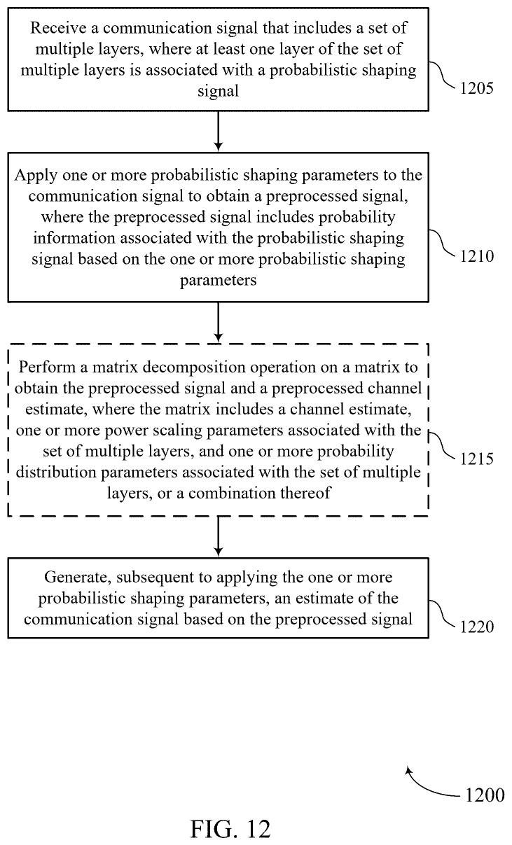

FIG. 12 shows a flowchart illustrating a method 1200 that supports probabilistic shaping and signal demodulation in accordance with one or more aspects of the present disclosure. The operations of the method 1200 may be implemented by a wireless communication device or its components as described herein. For example, the operations of the method 1200 may be performed by a wireless communication device as described with reference to FIGS. 1 through 9. In some examples, a wireless communication device may execute a set of instructions to control the functional elements of the wireless communication device to perform the described functions. Additionally, or alternatively, the wireless communication device may perform aspects of the described functions using special-purpose hardware.

At 1205, the method may include receiving a communication signal that includes a set of multiple layers, where at least one layer of the set of multiple layers is associated with a probabilistic shaping signal. The operations of 1205 may be performed in accordance with examples as disclosed herein. In some examples, aspects of the operations of 1205 may be performed by a signal receiving component 825 as described with reference to FIG. 8.

At 1210, the method may include applying one or more probabilistic shaping parameters to the communication signal to obtain a preprocessed signal, where the preprocessed signal includes probability information associated with the probabilistic shaping signal based on the one or more probabilistic shaping parameters. The operations of 1210 may be performed in accordance with examples as disclosed herein. In some examples, aspects of the operations of 1210 may be performed by a probabilistic shaping component 830 as described with reference to FIG. 8.

At 1215, the method may include performing a matrix decomposition operation on a matrix to obtain the preprocessed signal and a preprocessed channel estimate, where the matrix includes a channel estimate, one or more power scaling parameters associated with the set of multiple layers, and one or more probability distribution parameters associated with the set of multiple layers, or a combination thereof. The operations of 1215 may be performed in accordance with examples as disclosed herein. In some examples, aspects of the operations of 1215 may be performed by a decomposition operation component 845 as described with reference to FIG. 8.

At 1220, the method may include generating, subsequent to applying the one or more probabilistic shaping parameters, an estimate of the communication signal based on the preprocessed signal. The operations of 1220 may be performed in accordance with examples as disclosed herein. In some examples, aspects of the operations of 1220 may be performed by a demodulator component 835 as described with reference to FIG. 8.

The following provides an overview of aspects of the present disclosure:

Aspect 1: A method for wireless communications by a wireless communication device, comprising: receiving a communication signal that comprises a plurality of layers, wherein at least one layer of the plurality of layers is associated with a probabilistic shaping signal; applying one or more probabilistic shaping parameters to the communication signal to obtain a preprocessed signal, wherein the preprocessed signal includes probability information associated with the probabilistic shaping signal based at least in part on the one or more probabilistic shaping parameters; and generating, subsequent to applying the one or more probabilistic shaping parameters, an estimate of the communication signal based at least in part on the preprocessed signal.

Aspect 2: The method of aspect 1, further comprising: receiving an indication of the one or more probabilistic shaping parameters, wherein the one or more probabilistic shaping parameters are applied based at least in part on the indication.

Aspect 3: The method of any of aspects 1 through 2, further comprising: receiving an indication that the at least one layer of the plurality of layers is associated with the probabilistic shaping signal, wherein the one or more probabilistic shaping parameters are applied based at least in part on the indication.

Aspect 4: The method of any of aspects 1 through 3, wherein the one or more probabilistic shaping parameters comprise one or more first probabilistic shaping parameters and one or more second probabilistic shaping parameters, and wherein applying the one or more probabilistic shaping parameters comprises: applying the one or more first probabilistic shaping parameters to a first layer of the plurality of layers; and applying the one or more second probabilistic shaping parameters to a second layer of the plurality of layers that is different than the first layer.

Aspect 5: The method of any of aspects 1 through 4, further comprising: applying the one or more probabilistic shaping parameters to a channel estimate to obtain a preprocessed channel estimate, wherein the channel estimate is associated with a channel over which the communication signal is received, and wherein the estimate of the communication signal is generated based at least in part on the preprocessed channel estimate.

Aspect 6: The method of any of aspects 1 through 5, wherein applying the one or more probabilistic shaping parameters to the communication signal comprises: performing a matrix decomposition operation on a matrix to obtain the preprocessed signal and a preprocessed channel estimate, wherein the matrix comprises a channel estimate, one or more power scaling parameters associated with the plurality of layers, and one or more probability distribution parameters associated with the plurality of layers, or a combination thereof.

Aspect 7: The method of aspect 6, further comprising: obtaining the matrix based at least in part on combining a first matrix comprising the channel estimate and a second matrix comprising the one or more power scaling parameters and the one or more probability distribution parameters, wherein performing the matrix decomposition operation comprises: decomposing the matrix into a third matrix and a fourth matrix, the third matrix comprising the preprocessed channel estimate and the fourth matrix comprising an orthogonal matrix; and applying the fourth matrix to the communication signal to obtain the preprocessed signal.

Aspect 8: The method of any of aspects 6 through 7, wherein the matrix decomposition operation comprises a QR decomposition operation, a Cholesky decomposition operation, or both.

Aspect 9: The method of any of aspects 1 through 8, wherein the estimate of the communication signal comprises one or more LLRs for one or more information bits associated with the communication signal, the method further comprising: decoding the one or more information bits based at least in part on generating the one or more LLRs.

Aspect 10: The method of any of aspects 1 through 9, wherein generating the estimate of the communication signal comprises: inputting the preprocessed signal and a preprocessed channel estimate to a uniform QAM demodulator of the wireless communication device, wherein the uniform QAM demodulator generates the estimate of the communication signal based at least in part on the preprocessed signal and the preprocessed channel estimate.

Aspect 11: The method of aspect 10, further comprising: receiving a second communication signal comprising a second plurality of layers; determining that the second plurality of layers are not associated with a probabilistic shaping signal; inputting the second communication signal and a channel estimate to the uniform QAM demodulator based at least in part on the determining; and generating a second estimate of the second communication signal based at least in part on the second communication signal and the channel estimate.

Aspect 12: The method of any of aspects 1 through 11, further comprising: performing a whitening operation to the communication signal and a channel estimate prior to applying the one or more probabilistic shaping parameters to the communication signal, wherein the whitening operation converts noise associated with the communication signal to white noise.

Aspect 13: The method of any of aspects 1 through 12, further comprising: determining that at least one second layer of the plurality of layers is not associated with a probabilistic shaping signal; and setting a parameter of the one or more probabilistic shaping parameters associated with the at least one second layer to a value equal to 0 based at least in part on the determining, wherein generating the estimate of the communication signal is based at least in part on setting the parameter.

Aspect 14: A wireless communication device for wireless communications, comprising one or more memories storing processor-executable code, and one or more processors coupled with the one or more memories and individually or collectively operable to execute the code to cause the wireless communication device to perform a method of any of aspects 1 through 13.

Aspect 15: A wireless communication device for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communication device, comprising:
one or more memories storing processor-executable code; and
one or more processors coupled with the one or more memories and individually or collectively operable to execute the code to cause the wireless communication device to:
receive a communication signal that comprises a plurality of layers, wherein at least one layer of the plurality of layers is associated with a probabilistic shaping signal;
apply one or more probabilistic shaping parameters to the communication signal to obtain a preprocessed signal, wherein the preprocessed signal includes probability information associated with the probabilistic shaping signal based at least in part on the one or more probabilistic shaping parameters; and
generate, subsequent to applying the one or more probabilistic shaping parameters, an estimate of the communication signal based at least in part on the preprocessed signal.

2. The wireless communication device of claim 1, wherein the one or more processors are individually or collectively further operable to execute the code to cause the wireless communication device to:
receive an indication of the one or more probabilistic shaping parameters, wherein the one or more probabilistic shaping parameters are applied based at least in part on the indication.

3. The wireless communication device of claim 1, wherein the one or more processors are individually or collectively further operable to execute the code to cause the wireless communication device to:
receive an indication that the at least one layer of the plurality of layers is associated with the probabilistic shaping signal, wherein the one or more probabilistic shaping parameters are applied based at least in part on the indication.

4. The wireless communication device of claim 1, wherein the one or more probabilistic shaping parameters comprise one or more first probabilistic shaping parameters and one or more second probabilistic shaping parameters, and wherein, to apply the one or more probabilistic shaping parameters, the one or more processors are individually or collectively operable to execute the code to cause the wireless communication device to:
apply the one or more first probabilistic shaping parameters to a first layer of the plurality of layers; and
apply the one or more second probabilistic shaping parameters to a second layer of the plurality of layers that is different than the first layer.

5. The wireless communication device of claim 1, wherein the one or more processors are individually or collectively further operable to execute the code to cause the wireless communication device to:
apply the one or more probabilistic shaping parameters to a channel estimate to obtain a preprocessed channel estimate, wherein the channel estimate is associated with a channel over which the communication signal is received, and wherein the estimate of the communication signal is generated based at least in part on the preprocessed channel estimate.

6. The wireless communication device of claim 1, wherein, to apply the one or more probabilistic shaping parameters to the communication signal, the one or more processors are individually or collectively operable to execute the code to cause the wireless communication device to:
perform a matrix decomposition operation on a matrix to obtain the preprocessed signal and a preprocessed channel estimate, wherein the matrix comprises a channel estimate, one or more power scaling parameters associated with the plurality of layers, and one or more probability distribution parameters associated with the plurality of layers, or a combination thereof.

7. The wireless communication device of claim 6, wherein the one or more processors are individually or collectively further operable to execute the code to cause the wireless communication device to:
obtain the matrix based at least in part on combining a first matrix comprising the channel estimate and a second matrix comprising the one or more power scaling parameters and the one or more probability distribution parameters, wherein performing the matrix decomposition operation comprises:
decompose the matrix into a third matrix and a fourth matrix, the third matrix comprising the preprocessed channel estimate and the fourth matrix comprising an orthogonal matrix; and
apply the fourth matrix to the communication signal to obtain the preprocessed signal.

8. The wireless communication device of claim 6, wherein the matrix decomposition operation comprises a QR decomposition operation, a Cholesky decomposition operation, or both.

9. The wireless communication device of claim 1, wherein the estimate of the communication signal comprises one or more log-likelihood ratios for one or more information bits associated with the communication signal, and the one or more processors are individually or collectively further operable to execute the code to cause the wireless communication device to:
decode the one or more information bits based at least in part on generating the one or more log-likelihood ratios.

10. The wireless communication device of claim 1, wherein, to generate the estimate of the communication signal, the one or more processors are individually or collectively operable to execute the code to cause the wireless communication device to:
input the preprocessed signal and a preprocessed channel estimate to a uniform quadrature amplitude modulation (QAM) demodulator of the wireless communication device, wherein the uniform QAM demodulator generates the estimate of the communication signal based at least in part on the preprocessed signal and the preprocessed channel estimate.

11. The wireless communication device of claim 10, wherein the one or more processors are individually or collectively further operable to execute the code to cause the wireless communication device to:
receive a second communication signal comprising a second plurality of layers;
determine that the second plurality of layers are not associated with a probabilistic shaping signal;
input the second communication signal and a channel estimate to the uniform QAM demodulator based at least in part on the determining; and
generate a second estimate of the second communication signal based at least in part on the second communication signal and the channel estimate.

12. The wireless communication device of claim 1, wherein the one or more processors are individually or collectively further operable to execute the code to cause the wireless communication device to:
perform a whitening operation to the communication signal and a channel estimate prior to applying the one or more probabilistic shaping parameters to the communication signal, wherein the whitening operation converts noise associated with the communication signal to white noise.

13. The wireless communication device of claim 1, wherein the one or more processors are individually or collectively further operable to execute the code to cause the wireless communication device to:
determine that at least one second layer of the plurality of layers is not associated with a probabilistic shaping signal; and
set a parameter of the one or more probabilistic shaping parameters associated with the at least one second layer to a value equal to 0 based at least in part on the determining, wherein generating the estimate of the communication signal is based at least in part on setting the parameter.

14. A method for wireless communications by a wireless communication device, comprising:
receiving a communication signal that comprises a plurality of layers, wherein at least one layer of the plurality of layers is associated with a probabilistic shaping signal;
applying one or more probabilistic shaping parameters to the communication signal to obtain a preprocessed signal, wherein the preprocessed signal includes probability information associated with the probabilistic shaping signal based at least in part on the one or more probabilistic shaping parameters; and
generating, subsequent to applying the one or more probabilistic shaping parameters, an estimate of the communication signal based at least in part on the preprocessed signal.

15. The method of claim 14, further comprising:
receiving an indication of the one or more probabilistic shaping parameters, wherein the one or more probabilistic shaping parameters are applied based at least in part on the indication.

16. The method of claim 14, further comprising:
receiving an indication that the at least one layer of the plurality of layers is associated with the probabilistic shaping signal, wherein the one or more probabilistic shaping parameters are applied based at least in part on the indication.

17. The method of claim 14, further comprising:
applying the one or more probabilistic shaping parameters to a channel estimate to obtain a preprocessed channel estimate, wherein the channel estimate is associated with a channel over which the communication signal is received, and wherein the estimate of the communication signal is generated based at least in part on the preprocessed channel estimate.

18. The method of claim 14, wherein applying the one or more probabilistic shaping parameters to the communication signal comprises:
performing a matrix decomposition operation on a matrix to obtain the preprocessed signal and a preprocessed channel estimate, wherein the matrix comprises a channel estimate, one or more power scaling parameters associated with the plurality of layers, and one or more probability distribution parameters associated with the plurality of layers, or a combination thereof.

19. A non-transitory computer-readable medium storing code for wireless communications, the code comprising instructions executable by one or more processors to:
receive a communication signal that comprises a plurality of layers, wherein at least one layer of the plurality of layers is associated with a probabilistic shaping signal;
apply one or more probabilistic shaping parameters to the communication signal to obtain a preprocessed signal, wherein the preprocessed signal includes probability information associated with the probabilistic shaping signal based at least in part on the one or more probabilistic shaping parameters; and
generate, subsequent to applying the one or more probabilistic shaping parameters, an estimate of the communication signal based at least in part on the preprocessed signal.

20. The non-transitory computer-readable medium of claim 19, wherein the instructions are further executable by the one or more processors to:
receive an indication of the one or more probabilistic shaping parameters, wherein the one or more probabilistic shaping parameters are applied based at least in part on the indication.
